(19) United States
(12) Patent Application Publication
(10) Pub. No.: US 2011/0150625 A1
(43) Pub. Date: Jun. 23, 2011

(54) METHOD OF COAL DELIVERY TO A HEAT POWER PLANT FOR COMBUSTION

(75) Inventors: Chuluun Enkhbold, Ulaanbaatar (MN); Brodt Alexsander, Beer-sheva (IL)

(73) Assignee: ENKHBOLD, Chuluun, Ulaanbaatar (MN)

(21) Appl. No.: 13/059,983

(22) PCT Filed: Jul. 25, 2008
(86) PCT No.: PCT/IB2008/053002

§ 371 Date: Feb. 21, 2011

(51) Int. Cl. F23K 3/00; F23K 1/02; F27D 3/00

(52) U.S. Cl. 414/804

(57) ABSTRACT

The invention relates to the transportation and preparation for combustion of coal used as a solid fuel at heat power plants and can find applications in coal-based power generation. The object of the invention is a complex use of energy resources contained in coal, reduction of power consumption for the realization of the process, expansion of solid fuel pipeline transport application in coal-based power generation, increase in the coal pipeline operation safety, and the environment protection. Prior to the transportation via a pipeline, the initial stream of coal is screened into coarse material and fines, the latter being pressed into cylindrical monolithic blocks. Coal is transported via a pipeline filled with aqueous salt solution with a density exceeding that of the transported material, the coarse coal and pressed blocks being loaded into the pipeline alternately. At the power station, the coal delivered in the aqueous salt solution is separated from the liquid carrier, rinsed with water, dried and ground with simultaneous capturing of released methane. The effluents of rinsing are evaporated by heat released at the condensation of the working medium of the power plant thermodynamic cycle. The remaining stripped solution is mixed with liquid medium separated from the coal and returned to the starting point of the process.

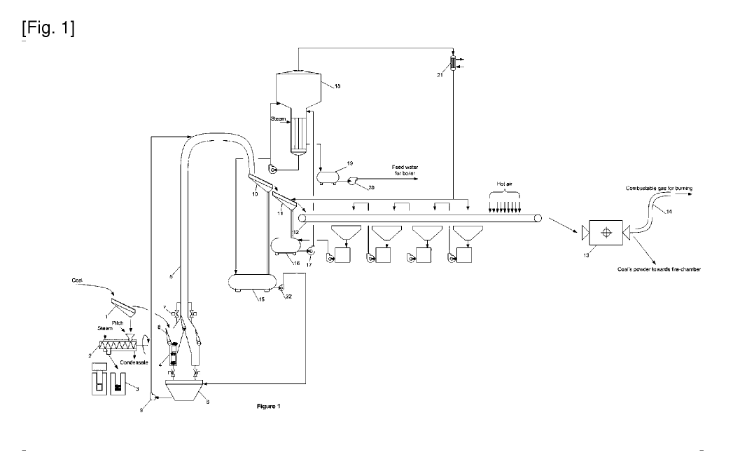

### TECHNICAL FIELD

The invention relates to the transportation and preparation for combustion of coal used as a solid fuel for electric power generation at heat power plants and can find applications in coal-based power generation.

### BACKGROUND ART

Pipeline transportation of coal in the form of coal-oil mixture is known (see, for instance, Kirilets O. M. Economic evaluation of certain kinds of pipeline transportation of coal over long distances. Theses of All-Union Seminar of young scientists in coal industry on the production of coal sections with 3-4-fold productivity in Kansk-Achinsk and other coalfields of eastern regions and processing of Kansk-Achinsk coal, Krasnoyarsk, 1982, 53-54).

For this purpose, coal is floured, mixed with black oil, and the ready coal-oil mixture is pumped through a trunk pipeline to its destination.

The described method is characterized by an extremely wasteful use of power resources (coal), since in the process of its flouring before mixing with black oil, practically all methane and other combustible hydrocarbon gases are irreversibly lost volatilizing into the atmosphere and causing, above all, irreparable harm to the environment due to their destructive action of the ozone layer of the Earth.

Besides, in case of pipeline depressurization, for instance, because of corrosive or erosive destruction, natural disaster (such as earthquake), man-caused accident or intentional sabotage of a terrorist band, leakage of the content of the pipeline into the environment threatens by an ecocatastrophe. This is especially dangerous is such transportation pipeline is laid on the sea or ocean bed.

Suspensions of fine coal in black oil are also characterized by anomalously high viscosity depending both on solid phase content and on temperature. Thus, the dynamic viscosity coefficient of such medium at 20 and 70° C. can exceed 6.53 or be below 0.19 Pa/sec. Such striking difference in the rheological property, which is fundamental for hydrotransport of any liquids, surely, adversely affects power consumption for pumping such superviscous medium over long distances through a trunk pipeline, since the head loss for overcoming the friction of said viscous flow against the walls of this thruway in the laminar mode is directly proportional to the dynamic viscosity coefficient value, not to speak about turbulized flows. Consequently, electric power consumption by pumps pumping said medium at 70° C. is 6.53:0.19=34.4 times lower than at 20° C. However, this brings about the necessity of laying a backup steam conduit heating the trunk pipeline in a common bundle with the latter (or coiling a special heating electric wire around it) covered with common thermal insulation, usually rather expensive, which is connected with elevated consumption of graded power resources.

The closest to the method of the invention is the hydraulic coal transportation method consisting in the preliminary grinding of the material to be delivered to a heat power plant with a subsequent slurrying of the produced fine coal powder in water and pumping of the prepared suspension to the heat power plant through a trunk pipeline (see, for instance, Bonnington S.T. Developments in the Hydraulic Transport of Coal, Coal Preparation, 2, pp. 219-223, November/December 1966).

Besides the irreversible loss of methane and other combustible hydrocarbon gases in the process of coal preparation for transportation to its destination place, which characterizes this method as resource-wasting and ecologically dirty, solid fuel delivery to a heat power plant in said finely ground state also entails a number of serious technological problem at the place of its arrival. They are connected with difficulties in concentration, filtration and drying of such finely dispersed material, since with growing fineness, the specific area of its external surface sharply increases with a simultaneous decrease in the weight of each separate particle. This leads to a considerable drop in the concentration rate of such suspensions, exponential growth of moisture retained by residues formed during the filtration, and a considerable increase in the solid phase skip into the filtrate, which is contaminated in this case not only with coal cloud, but also with phenol and other toxic organic water-soluble impurities actively extracted from the coal in the process of its prolonged contact with water.

If instead of concentrating, dehydrating and drying coal at the place of its arrival to the heat power plant, water-coal suspension is immediately directed to the boiler furnace for combustion, a sharp decrease in the coefficient of efficient use of the combustion heat of such solid fuel is inevitable. It is due to the fact that a considerable part of its calorific value is spent only for the evaporation of all the water from such flow, and said water is characterized, in contrast to non-aqueous liquids, by an anomalously high value of the latent evaporation heat, and not for the production of high-pressure working vapor in the boiler, which represents a working medium of the thermodynamic cycle of the solid fuel chemical potential transformation into electric energy. Moreover, this technological process is a source of irreversible consumption of enormous amounts of water commensurate with the volumes of coal pumped through it.

At the same time, no matter how thin is the solid phase of the pumped suspension, in case of a sudden interruption of the electric power supply and, respectively, of an emergency shutdown of pumping stations, an actual threat of an irreversible stratification of the suspension in the pipeline into water clarified from coal and a corresponding deposit arises, which can lead in many cases of choking of said many-kilometer transport communication at the renewal of the electric power supply.

In this connection, it should be noted that coal pumping in the for of suspension through a trunk pipeline cannot be realized in the laminar flow mode, but only at a sufficiently high turbulization of the flow preventing the solid phase settling-out. However, the growth of hydrodynamic head produced in this case by pumps is accompanied by inadequate increase in their energy consumption, since energy loss for the flow acceleration to the required velocity is proportional to its velocity squared. It should be added that with increasing rate of pumping such suspensions, the erosive wear of pipes under the action of strong wearing influence of said abrasive medium on the pipeline material is sharply intensified.

At a destruction of a pipeline caused by corrosive, erosive or other damage or a terrorist act, the emission of its content causing severe ecological harm to the natural environment, which will be polluted with coal slush, is inevitable.

It is also noteworthy that the relatively high (for climatic conditions of overwhelming majority of leading coal-producing countries in the world) water freezing temperature makes the described method practically inapplicable in winter, especially in regions with severe winter colds and permanent frost zones. This limits the areas of its application by territories located in southern and equatorial latitudes of permanent summer weather.

### DISCLOSURE OF INVENTION

### Technical Problem

### Technical Solution

The objects of the invention include a complex use of energy resources contained in coal, reduction of power consumption for the realization of the process, expansion of solid fuel pipeline transport application in coal-based power generation, environment protection from the emission of ozone-destroying gases, increase in the operation safety level of the transportation system and decrease in the damage caused by possible accidents and terrorist attacks.

These objectives are realized by classifying the initial stream of coal (before its transportation through a pipeline) into coarse material and fines, which are pressed into piston-shaped monolithic blocks loaded afterwards into a pipeline filled with aqueous liquid with the density exceeding that of the transported material so that coarse coal is alternated with coal pressed into blocks, and after the separation of coal delivered in the aqueous liquid flow to its destination, said coal is rinsed with water, dried and ground with simultaneous capturing of the released methane and other combustible gases directed later to the combustion, wherein the waste flow left after rinsing is evaporated by heat released at the condensation of the working medium of the heat power plant thermodynamic cycle, whereas the product of the process is mixed with liquid medium separated from the coal and returned to the starting point of the process.

Individual mineral salts solutions with high water solubility and, consequently, a low freezing temperature, as well as their various multi-component mixtures, for instance, calcium, zinc, tin, antimony or ferric iron chlorides, bromides of the same metals, calcium and zinc nitrates, potassium carbonate, etc. can be used as aqueous liquid with the density exceeding that of coal for realizing the method of the invention.

Solid fuel delivery to a heat power plant by pipeline transport in the bulky form only, with the subsequent grinding of the delivered material at its destination place makes it possible not only to prevent a number of problems caused by the transportation of coal flour stirred-up in water, but also to retain methane and other hydrocarbon gases contained in the coal in the occluded form, using coarse pieces, lumps and monolithic blocks of coal as peculiar containers for a free delivery of combustible gases contained in them to their combustion place together with their carrier medium.

Coarse size of the delivered material ensures a much higher safety of the transporting pipeline operation, especially when it is laid on the sea or ocean bed, because in case of its local damage (even ill-intentioned one), a sudden emission of the transported material into the environment is excluded. Only the leakage of the carrying liquid into the soil or its ingress into sea water is possible. Besides, this liquid is not a coal slush, but an absolutely ecologically safe aqueous solution of, for instance, calcium chloride, which is a component of mineral salts dissolved in sea-water and used in medicine for intravenous injections, or calcium nitrate, which is used in agriculture as a highly efficient mineral fertilizer. The absence of an objective necessity of the pumped flow turbulization allows coal transportation through a pipeline in a purely laminar mode of the carrying liquid. It cardinally decreases the power consumption of this transportation process and, besides, prevents the erosive wear of pipes. Moreover, the fact that the most part of the pipeline volume is usefully filled with coal, and not with the carrying liquid, combined with the utilization of the free condensation heat of the working medium of the thermodynamic cycle for the regeneration of aqueous liquid with the density exceeding that of coal, which is contained in a totally closed circulation cycle, makes energy saving the principal distinctive feature characterizing the advantages of the method of the invention.

From the standpoint of electric power economy, efficient use of natural relief is also of importance. Namely, in case of natural difference between geodesic marks of the origin and destination points, as it happens at the development of mountainous coal deposits, there is a possibility of organizing non-pressure coal hydrotransport, which allows gravity delivery of solid fuel to electric power stations located in a flat territory by trunk pipelines. This process is similar to logs floating by rivers.

From the standpoint of maintenance, the method of the invention also advantageously differs from the prototype, since in case of emergency interruption of the electric power supply, clogging of such thruway is excluded irrespective of the idle time duration, because coal remains afloat in this liquid, no matter whether it moves or is motionless.

At the same time, low freezing temperatures of aqueous solutions of mineral salts in use ensure reliable operation of such transportation systems not only in southern latitudes, but also in extreme northern regions, in permanent frost conditions, at the temperatures down to −40 . . . −50° C.

Thus, all features of the invention are closely interconnected, and such combination of these features ensures the accomplishment of the object of the invention. No engineering solutions in this field, similar in their technical idea and positive effect attained, have been found in the course of patent search and analysis of materials published in scientific and technical literature.

Hence, the invention possesses novelty and relevance of its characteristic features, which leads to a conclusion about its inventive character.

### Advantageous Effects

### Description of Drawings

The method of the invention is realized by the following sequence of operations:
classification of the initial material into lumpy coal and fines;
pressing fines into bulky monolithic piston-shaped blocks;
alternate loading of batches of lumpy coal alternating with ‘pistons’ of coal pressed into monolithic blocks into the transport pipeline filled with a heavy water-salt medium and simultaneous formation of the flow of aqueous liquid with the density exceeding that of coal in the horizontal section of the pipeline;
delivery of coal loaded into the transport pipeline to its destination in the flow of its liquid medium;
hydromechanical separation of coal delivered to the heat power plant from the carrier liquid by drainage;
rinsing of dewatered coal with water from the residues of mineral salt aqueous solution on the surface of coal lumps, bulks and blocks;
drying of coal rinsed with water from the carrier medium;
dry coal grinding with simultaneous capturing of the released methane and other hydrocarbon gases directed to the boiler of the heat power plant furnace for combustion;
evaporating rinsing water left after the coal rinsing with heat released at the condensation of the working medium of the heat power plant thermodynamic cycle down to the initial density of water-salt solution;
mixing of the resulting rinsing water with the liquid carrier separated earlier from the coal delivered to the heat power plant and return of thus regenerated aqueous liquid with the density exceeding that of coal to the starting point of the transportation process.

### EXAMPLE

The essence of the method of the invention is clarified by a flow chart of the operation of pipeline transport shown in an attached FIGURE illustrating the technology of direct drawing of coal from a coal mine to a heat power plant, if the produced coal does not need beneficiation and can be burnt in its furnaces as is. In this case, it is no longer necessary to construct pit-shafts and skip hoists operating in a pronounced cyclic mode.

(If the produced coal needs beneficiation, a transportation system for coal delivery from a coal-cleaning plant to the heat power plant looks similarly).

Coal stream delivered from mining faces to the shaft bottom is classified on separator 1 into lumpy material and fines comprising both fine pieces of coal and all its dusty fractions.

Coal fines separated from lumps and large pieces are fed by screw feeder 2 equipped with a heat-exchange jacket to press mold 3 for pressing. A moderate amount of pitch is introduced into screw feeder 2 as a binding additive, which strengthens monolithic blocks made from coal fines in the form of cylindrical bodies resembling pistons of hydraulic facilities by their shape. Steam for heating coal mixture with pitch before pressing is fed into its heat-exchange jacket.

Batches of lumpy coal and coal blocks apiece are alternately arranged in loading chamber 4 of the loading system of transport pipeline 5 in such a way that coal ‘pistons’ are alternated with batched of the pourable mixture of pieces with lumps of coal. Loading chambers 4 are alternately emptied, in the antiphase to each other, from the liquid filling them, which constitutes the working medium of the entire transport process representing an aqueous solution of calcium nitrate with the density 1.42 g/cm³ (the coal density being 1.39 g/cm³).

Discharged portions of this liquid are collected in waste container 6, while loading chambers 4 are alternately flooded with the contents of pipeline 5, after being loaded with coal, using cocks 7 and a system of controllable shutoff gates 8. As a result, the coal floats out of the mine to the ground surface and then floated in the flow of the carrying aqueous medium to its destination. The flow of said liquid carrier in the horizontal part of pipeline 5 is generated by feeding a liquid jet by pump 8 from waste container 6.

(However, in case of the development of mountainous coal deposits, it is much more energy-profitable to use gravity-based operation of said hydrotransport, without generating an artificial flow of the carrier liquid in the transport pipeline).

The coal delivered to the heat power plant is hydromechanically separated from the carrying liquid on separator 10, and then rinsed with fresh water on separator 11 and overloaded to band vacuum-filter 12, where it is additionally washed with water in the counter-current mode, finally squeezed from the residues of washing water and dried with hot air or some other heat-transfer medium before starting grinding the former for producing dusty fuel.

Coal powdering is carried out in hermetic ball mill 13. Methane and other combustible gases released during this process enter pipeline 14 directing them to the boiler furnace of the heat power plant together with coal.

Drainage waste left from coal on shaker 10 are accumulated in collector 15, whereas washing water left after its rinsing on shaker 11, as well as final filtrate from band vacuum-filter 12 are directed to collector 16, wherefrom this technological flow is directed by pump 17 to evaporation in evaporating system 18.

Evaporation of this washing water is realized at the expense of condensation heat of the exhaust steam leaving turbines of the heat power plant, which represents a working medium of its thermodynamic cycle of coal combustion heat transformation into electric power. Therefore, the condensate formed in the intertube space of steam-generating tubes of evaporating system 18 flowing down into collector 19 is directed again by pump 20 to the steam-boiler of the heat power plant, where it is processed again into high-pressure working steam directed to steam turbines for expansion, closing in this way, the working medium circulation in the cycle of thermal energy conversion into electric one.

Juice water steam left after the evaporation of washing water in evaporating system 18 is condensed in condenser 21 and returned, in the form of hot washing water, to shaker 11 and band vacuum-filter 12 for coal rinsing.

Aqueous salt solution evaporated in evaporating system 18 up to its initial density of 1.42 g/cm³ is mixed in collector 15 with drainage flow left after coal dewatering on shaker 10. The obtained mixture representing a completely regenerated aqueous liquid with the density exceeding that of coal is returned by pump 22 into container 6, to the initial loading site of coal supply.

Application of the method of the invention ensures, first of all, a more complete utilization of the energy potential contained in energy carrier transported using said method, because in this case not only solid fuel delivered to a heat power plant, but also methane and other hydrocarbon gases are brought to combustion, which both increases its energy value and protects the ozone layer of the Earth stratosphere from the harmful effect of ozone-destroying gases. Taking into account a cardinal decrease in energy consumption by this transportation system and practical absence of any limitations connected with climatic conditions of said pipeline transport operation, the advantages of this continuous non-stop system of coal delivery directly from coal-producing enterprise to its destination become even more significant. A considerable increase in the safety level of the operation of said transportation system is also of great importance, since in case of accidental depressurization of transportation pipeline or a terrorist act, substantial environment pollution with coal is excluded, because the latter is in a non-dissipated form.

### BEST MODE

### Mode for Invention

### INDUSTRIAL APPLICABILITY

### Sequence List Text

1. A method of coal delivery to a heat power plant for combustion comprising its loading into a pipeline filled with an aqueous medium, transportation in its flow to a destination place, hydromechanical separation from the liquid phase and drying before the combustion, wherein in order to realize multipurpose utilization of energy resources of the coal, to decrease power consumption for the transportation process, to protect the environment from the destruction of the ozone layer of the Earth by hydrocarbon gases, to increase safety level and to expand the application area of pipeline transportation of solid fuel, before the loading, the initially supplied coal is classified into coarse material and fines that are pressed into monolithic piston-shape blocks, which are loaded into a pipeline filled with an aqueous liquid with the density exceeding that of coal, alternating them with batches of pourable coarse material floated in the flow of said liquid medium through the pipeline to its destination place, and after the hydromechanical separation of the coal delivered to the heat power plant from the liquid phase, it is rinsed with water, dried and ground with a simultaneous capturing of the released hydrocarbon gases directed for combustion, wherein washing water left after the coal rinsing is evaporated by heat released at the condensation of the working medium of the heat power plant thermodynamic cycle and returned, together with drainage water hydromechanically separated from coal, to the loading place. A method according to claim 1, wherein calcium nitrate solution in water is used as the aqueous liquid with the density exceeding that of coal.
